(19) United States
(12) Patent Application Publication
(10) Pub. No.: US 2024/0398008 A1
(43) Pub. Date: Dec. 5, 2024

(54) CARTRIDGE WITH LEAKAGE PROTECTION FOR AEROSOL-GENERATING DEVICE

(71) Applicant: Philip Morris Products S.A., Neuchatel (CH)

(72) Inventors: Rui Nuno Rodrigues Alves BATISTA, Morges (CH); Alexandra SEREDA, Neuchâtel (CH)

(73) Assignee: Philip Morris Products S.A., Neuchatel (CH)

(21) Appl. No.: 18/700,406

(22) PCT Filed: Oct. 19, 2022
(86) PCT No.: PCT/EP2022/079020

§ 371 Date: Apr. 11, 2024

(30) Foreign Application Priority Data
Oct. 20, 2021 (EP) 21203689.1
Nov. 9, 2021 (EP) 21207060.1

(51) Int. Cl. A24F 40/42; A24F 7/00; A24F 40/10; A24F 40/44; A24F 40/465; A24F 40/48; A24F 40/49

(52) U.S. Cl. CPC A24F 40/42; A24F 7/00; A24F 40/10; A24F 40/44; A24F 40/465; A24F 40/48; A24F 40/49

(57) ABSTRACT

A cartridge assembly for an aerosol-generating device is provided, the cartridge assembly including: a mouthpiece including a sealing portion; and a liquid storage portion including a fluid-permeable portion, the mouthpiece and the liquid storage portion being axially movable relative to each other between a first position and a second position, in which, in the first position, the fluid-permeable portion of the liquid storage portion is sealed by the sealing portion of the mouthpiece, and in which the fluid-permeable portion of the liquid storage portion is a tubular wick element. A method for establishing a fluid flow in the cartridge assembly is also provided. An aerosol-generating system including the cartridge assembly and an aerosol-generating device is also provided.

The present disclosure relates to a cartridge for an aerosol-generating device. The present disclosure further relates to an aerosol-generating device. The present disclosure further relates to an aerosol-generating system comprising an aerosol-generating device and a cartridge. The present disclosure further relates to a method comprising a cartridge for an aerosol-generating device.

It is known to provide an aerosol-generating device for generating an inhalable vapor. Such devices may heat an aerosol-forming substrate contained in a cartridge without burning the aerosol-forming substrate. The aerosol-generating device may comprise a heating arrangement. The heating arrangement may be an induction heating arrangement and may comprise an induction coil and a susceptor. The susceptor may be part of the device or may be part of the cartridge.

Upon heating to a target temperature, the aerosol-forming substrate vaporises to form an aerosol. The aerosol-forming substrate may be present in solid form or in liquid form. Liquid aerosol-forming substrate may be comprised in a liquid storage portion and may be delivered to the heating element via a capillary component. The liquid storage portion may form part of the cartridge.

It would be desirable to have a cartridge that prevents leakage of liquid aerosol-forming substrate. It would be desirable to have a cartridge that prevents leakage of liquid aerosol-forming substrate during storage. It would be desirable to have a cartridge that prevents leakage of liquid aerosol-forming substrate during use. It would be desirable to have a cartridge that is child secure. It would be desirable to have a cartridge that incorporates child-proof features. It would be desirable to provide a cartridge that can be used within the cavity of existing induction heating aerosol-generating devices.

According to an embodiment of the invention there is provided a cartridge assembly for an aerosol-generating device. The cartridge assembly may comprise a mouthpiece comprising a sealing portion and a liquid storage portion comprising a fluid permeable portion. The mouthpiece and the liquid storage portion may be axially movable relative to each other between a first position and a second position. In the first position, the fluid permeable portion of the liquid storage portion may be sealed by the sealing portion of the mouthpiece.

According to an embodiment of the invention there is provided a cartridge assembly for an aerosol-generating device. The cartridge assembly comprises a mouthpiece comprising a sealing portion and a liquid storage portion comprising a fluid permeable portion. The mouthpiece and the liquid storage portion are axially movable relative to each other between a first position and a second position. In the first position, the fluid permeable portion of the liquid storage portion is sealed by the sealing portion of the mouthpiece.

The first position may be a sealed position and the second position may be an open position. The first position may be a position for storage of the cartridge assembly. The second position may be a position for usage of the cartridge assembly with an aerosol-generating device. The first position may prevent use of the cartridge assembly with an aerosol-generating device. The second position may allow use of the cartridge assembly with an aerosol-generating device.

Providing a cartridge assembly that can be axially moved between a first sealed position and a second open position may avoid leakage of liquid aerosol-forming substrate. Providing a cartridge assembly that can be axially moved between a first sealed position and a second open position may prevent leakage of liquid aerosol-forming substrate during storage. Providing a cartridge assembly that can be axially moved between a first sealed position and a second open position may allow the user to flexible switch between use and storage of the cartridge assembly. Providing a cartridge assembly that can be axially moved between a first locked position and a second unlocked position may be child secure.

It is known to provide a system of an aerosol-generating device with a cartridge. The cartridge can comprise liquid aerosol-forming substrate in a storage portion. The cartridge or storage portion may be sealed by a foil which needs to be peeled of before the use. After removal of such a foil, the cartridge may be irreversible opened. Storage of such a cartridge may be impossible thereafter, as the cartridge could leak or dry out. Therefore, a cartridge assembly comprising reversible sealing elements would be very convenient for the user.

An aerosol-generating device may be in a household with small children. A child may be able to push a starting button of an aerosol-generating device. Thereby, a child may inhale substances that are not intended for children. Therefore, a cartridge assembly that provides a locked position may be also child secure.

The mouthpiece and the liquid storage portion may be axially movable towards or apart from each other between the first position and the second position. The movement of the mouthpiece and the liquid storage portion may be along the longitudinal axis of the cartridge assembly. The movement may be reversible.

The first position may be an extended position and the second position may be a retracted position. The mouthpiece and the liquid storage portion may be connected in the extended position. The mouthpiece and the liquid storage portion may be connected in the retracted position.

In the first position, a proximal end of the mouthpiece and a distal end of the liquid storage portion may be axially more distanced than in the second position. The proximal end of the mouthpiece may be a mouth end. The proximal end may comprise an air outlet. A combined axial length of the mouthpiece and the liquid storage portion may be greater in the first position than in the second position.

The fluid permeable portion may comprise a material permeable to fluids, preferably the fluid permeable portion may be a material permeable to fluids. The fluid permeable portion may comprise a fluid permeable barrier, preferably the fluid permeable portion may be a fluid permeable barrier. The fluid permeable portion may comprise a fluid permeable membrane, preferably the fluid permeable portion is a fluid permeable membrane. The fluid permeable portion may comprise a porous portion, preferably the fluid permeable portion is a porous portion. The fluid permeable portion may be only permeable to fluids. The fluid permeable portion may not simply be only an opening in a wall of the liquid storage portion.

The mouthpiece and the liquid storage portion may be lockingly engaged in the first position. The mouthpiece and the liquid storage portion may be lockingly engaged in the second position. The locked engagement in the first and in the second position may prevent a complete disengagement of the mouthpiece and the liquid storage portion. The locked engagement in the first position may prevent a loss of the mouthpiece during storage. The locked engagement in the second position may prevent a loss of the mouthpiece during usage. The mouthpiece and the liquid storage portion may be attached to each other in the first and in the second portion.

The mouthpiece may be configured to receive a top portion of the liquid storage portion. The mouthpiece may comprise a peripheral wall. The peripheral wall may merge into the proximal end of the mouthpiece. The peripheral wall may confine a cavity. The mouthpiece may receive the top portion of the liquid storage portion within the cavity. The top portion of the liquid storage portion may be a proximal end. The cavity may have a width measured in a direction orthogonal to the longitudinal axis of the cartridge assembly. The width of the cavity may be greater than a width of the top portion of the liquid storage portion measured in the same direction. The cavity of the mouthpiece and the top portion of the liquid storage portion may have matching shapes.

The mouthpiece may further comprise a tubular air management element confining an airflow channel. The tubular air management element may comprise the sealing portion.

The tubular air management element may comprise the sealing portion at a distal position. The tubular air management element may be circumscribed by the sealing portion. The tubular air management element may be hollow. The mouthpiece and the tubular air management element may be coaxial. The tubular air management element may comprise a distal opening.

The tubular air management element may be within the cavity of the mouthpiece. The tubular air management element may be attached to the proximal end of the mouthpiece. An axial length of the tubular air management element may be greater than an axial length of the peripheral wall. The tubular air management element may protrude from the cavity of the mouthpiece.

The tubular air management element may comprise a tubular porous portion. The porosity of the tubular porous portion may be in a range of between 35 percent to 80 percent, preferably of between 45 percent to 65 percent, most preferably of between 50 percent to 60 percent. The tubular porous portion may be fluid permeable.

As used herein, the ‘porosity’ is defined as the percentage of a unit volume which is void of material. The porosity is may be derived using standard method and equation giving a decimal value for porosity. Knowing the pore volume of a defined volume of material (Vp) and its total volume (Vt), porosity (Pt) is given by the ratio Vp/Vt. To express porosity as a percent, that decimal is simply multiplied by 100%. For example, Pt=0.51, therefore 0.51×100%=51%.

A part of the tubular air management element may be the tubular porous portion. For example, 10 percent of the length of the tubular air management element may be configured as the tubular porous portion. The tubular porous portion may be at a distal portion of the tubular air management. The tubular air management element may be slightly expanded at the tubular porous portion.

The tubular air management element may comprise a heating element arranged adjacent the tubular porous portion. The heating element may be coaxially circumscribed by the tubular porous portion. The heating element may be in direct contact with the tubular porous portion. The tubular porous portion may comprise the heating element. The heating element may be embedded into the tubular air management element. The heating element may be embedded into the expanded tubular porous portion. Thereby the heating element may be positioned within the tubular air management element.

The heating element may be a susceptor heating element. The susceptor heating element may be a porous susceptor heating element. The porosity of the susceptor heating element may be in the range of 25 percent to 80 percent, preferably 55 percent to 75 percent, more preferably 65 percent to 75 percent. The porosity of the susceptor heating element may provide effective heating. The susceptor may be tubular. The susceptor heating element may be a tubular porous susceptor. The susceptor heating element may be hollow. The susceptor heating element may be air flowable. The porosity of the porous susceptor may be the same than the porosity of the tubular porous portion of the tubular air management element. The porosity of the porous susceptor and the tubular porous portion of the tubular air management element may be different.

The liquid storage portion may comprise a liquid reservoir and a hollow tubular core element. The hollow tubular core element may be circumscribed by the liquid reservoir. The hollow tubular core element may comprise the fluid permeable portion arranged at a distal end of the liquid reservoir. The hollow tubular core element may be configured to receive the tubular air management element of the mouthpiece. The tubular air management element may be axially movable within the hollow tubular core element of the liquid storage portion.

The hollow tubular core element may comprise a tubular wall. The tubular wall may have an internal diameter measured in a direction orthogonal to the longitudinal axis of the cartridge assembly. The internal diameter of the tubular wall may be greater than an external diameter of the tubular air management element measured in the same direction. An axial length of the hollow tubular core element may be approximately the same than the axial length of the tubular air management element.

The liquid storage portion may comprise a proximal transversal wall. The liquid storage portion may comprise a peripheral wall. The liquid reservoir may be confined by the proximal transversal wall and the peripheral wall of the liquid storage portion and by the tubular wall of the hollow tubular core element.

The liquid storage portion may further comprise a distal connection element. The distal connection element may be configured to be connected to an aerosol-generating device.

The fluid permeable portion of the liquid storage portion may be a tubular wick element. The fluid permeable barrier may be a tubular wick element. The tubular wick element may be a porous ceramic wick element. The porosity of the ceramic wick element may be between 30 percent to 80 percent, preferably 40 percent to 70 percent, most preferably 50 percent to 60 percent. The porous ceramic wick element may trap potential leakage of liquid aerosol-forming substrate or sensorial media. The porosity of the tubular wick element may prevent free flow of the aerosol-forming substrate or liquid sensorial media.

In the second position, the fluid permeable portion and the heating element may be transversally aligned so that the tubular porous portion may be in direct contact with the fluid permeable portion to provide a fluid connection from the liquid reservoir towards to the heating element. The fluid permeable portion and the heating element may not be aligned in the first position. Thereby the flow of the aerosol-forming substrate or liquid sensorial media may only be provided when the user desires it.

The liquid storage portion may comprise a first locking element at an outer surface. The mouthpiece may comprise a second locking element at an inner surface. Alternatively, the liquid storage portion may comprise the second locking element at an outer surface and the mouthpiece may comprise the first locking element at an inner surface. The first locking element and the second locking element may be configured to lockingly engage with each other. The first and second locking elements may provide the locked engagement. The first and second locking elements may attach the mouthpiece to the liquid storage portion. The first and second locking elements may attach the liquid storage portion to the mouthpiece. The first or second locking elements may be positioned in a proximal portion of the liquid storage portion. The first or second locking elements may be positioned in a proximal portion of the mouthpiece.

The liquid storage portion may comprise the first locking element on an outer side of the proximal transversal wall. The outer side of the proximal transversal wall may comprise the first locking element at an outer position. The liquid storage portion may comprise the second locking element on an outer side of the peripheral wall.

The mouthpiece may comprise the second locking element on an inner side of the peripheral wall. The mouthpiece may comprise the first locking element on an inner side of the peripheral wall.

Alternatively, the liquid storage portion and the mouthpiece may comprise both of a first and a second locking element, respectively.

The first locking element and the second locking element may comprise male and female connection elements. The first locking element and the second locking element may comprise form-fit connection elements. The first locking element and the second locking element may comprise snap-fit connection elements. The first locking element and the second locking element comprise bayonet connection elements. The first locking element and the second locking element may comprise other connection elements know to the skilled person.

The first and second locking elements may be configured to disengage when the mouthpiece and the liquid storage portion are axially moved from the first position to the second position, or vice versa. The first and second locking elements may be configured to disengage when the mouthpiece and the liquid storage portion are axially moved from the second position to the first position.

The first locking element may comprise an elastic protrusion. The second locking element may comprise a distal recess. The elastic protrusion may be configured to lockingly engage with the distal recess in the first position. A distal end of the elastic protrusion may be configured to be inserted into the distal recess. The distal end of the elastic protrusion and the distal recess may have matching shapes.

The second locking element may comprise a proximal recess. The proximal recess may be closer to the proximal end of the mouthpiece than the distal recess. The elastic protrusion may be configured to lockingly engage with the proximal recess in the second position. The elastic protrusion and the proximal recess may have matching shapes. A part of the elastic protrusion may be configured to be inserted into the proximal recess. A distal end of the elastic protrusion may be configured to be inserted into the proximal recess.

The elastic protrusion may comprise two oppositely arranged transversally extending elastic protrusions. The distal recess may comprise two oppositely arranged recesses. The transversally extending elastic protrusions may be configured to lockingly engage with the two oppositely arranged recesses in the first position. The proximal recess may comprise two oppositely arranged recesses. The transversally extending elastic protrusions may be configured to lockingly engage with the two oppositely arranged recesses in the second position. The elastic protrusion and the distal and proximal recesses may provide child-proof features.

A distance of the two distal ends of the two oppositely arranged transversally extending elastic protrusions may be greater than a distance of the two oppositely arranged recesses of the proximal recess. The distance of the distal ends of the two oppositely arranged transversally extending elastic protrusions may be greater than a distance of the two oppositely arranged recesses of the distal recess.

When the cartridge assembly is in the first or in the second position the two oppositely arranged transversally extending elastic protrusions may be in a relaxed position. When the cartridge assembly is between the first and second position the two oppositely arranged transversally extending elastic protrusions may be in a bend position.

The two oppositely arranged transversally extending elastic protrusions may be arranged on the proximal transversal wall of the liquid storage portion. The two oppositely arranged elastic protrusions may be arranged on the proximal transversal wall on an outer position. The distance of the distal ends of the two oppositely arranged elastic protrusions may be greater than the width of the liquid storage portion at the proximal end.

Alternatively, the first and second locking elements may extend radially with respect to the longitudinal axis of the cartridge. The elastic protrusion may extend around an outer perimeter of the proximal transversal wall of the liquid storage portion. The distal recess and the proximal recess may extend peripheral around the inner side of the peripheral wall of the mouthpiece. The elastic protrusion may extend peripheral around the inner side of the peripheral wall of the mouthpiece. The distal recess and the proximal recess may extend peripheral around the outer side of the peripheral wall of the liquid storage portion. The elastic protrusion may be an annular protrusion. The distal recess may be an annular distal recess and the proximal recess may be an annular proximal recess.

The sealing portion may comprise a tubular sealing element. The tubular sealing element may circumscribe a distal portion of the tubular air management element. The tubular sealing element may be arranged distal to the porous portion. The tubular sealing element may have at least the same axial length as the tubular wick element. The axial length of the tubular sealing element may be greater than the axial length of the tubular wick element. The tubular sealing element may seal the tubular wick element and the liquid reservoir, when the cartridge assembly is in the first position. The tubular sealing element may be in direct contact with the tubular wick element, when cartridge assembly is in the first position. Thereby providing leakage prevention during storage of the cartridge assembly.

The tubular sealing element may be liquid impermeable. The tubular sealing element may comprise a rubber material. The tubular sealing element may have an external diameter measured in a direction orthogonal to the longitudinal axis of the cartridge assembly. The external diameter of the tubular sealing element may be approximately the same than an internal diameter of the tubular wick element measured in the same direction. The external diameter of the tubular sealing element may be approximately the same than the internal diameter of the hollow tubular core element of the liquid storage portion.

The sealing portion may further comprise a first ring-shaped sealing element and a second ring-shaped sealing element. The tubular sealing element may be arranged between the first and second ring-shaped sealing elements. The tubular sealing element may be sandwiched between the first and second ring-shaped sealing elements. The first and second ring-shaped sealing elements may circumscribe the tubular air management element.

The first ring-shaped sealing element may be arranged adjacent to a distal end of the tubular sealing element. The second ring-shaped sealing element may be arranged adjacent to a proximal end of the tubular sealing element. The first and second ring-shaped sealing elements may provide sealing of the tubular sealing element. The first and second ring-shaped sealing elements may prevent leakage from the tubular sealing element.

The first and second ring-shaped elements may be in contact with the tubular sealing element. Alternatively, the first and second ring-shaped elements may not be in contact but in close proximity to the tubular sealing element. Thereby providing a gap between the first ring-shaped sealing element and the tubular sealing element and an additional gap between the tubular sealing element and the second ring-shaped sealing element. If liquid aerosol-forming substrate or sensorial media contained is leaking beyond the tubular wick element the leakage may be trapped within the gaps.

The mouthpiece may further comprise a third ring-shaped sealing element. The tubular porous portion may be arranged between the second and the third ring-shaped sealing elements. The tubular air management element may comprise the third ring-shaped sealing element. The third ring-shaped sealing element may circumscribe the tubular air management element.

The first, second and third ring-shaped sealing elements may have the same external diameter measured in a direction orthogonal to the longitudinal axis of the cartridge assembly. The external diameter of the first, second and third ring-shaped sealing elements may be approximately the same than an internal diameter of the tubular air management element measured in the same direction. The external diameter of the first, second and third sealing elements may be approximately the same than the internal diameter of the hollow tubular core element of the liquid storage portion.

The ring-shaped sealing elements may be configured as o-rings.

The first and second ring-shaped sealing elements may be configured to hermetically seal the tubular wick element, when the cartridge assembly is in the first position. The second and third ring-shaped sealing elements may be configured to hermetically seal the tubular wick element, when the cartridge assembly is in the second position. The first and second ring-shaped sealing elements may prevent leakage during storage of the cartridge assembly, when the cartridge assembly is in the first position. The second and third ring-shaped sealing elements may prevent leakage during usage of the cartridge assembly, when the cartridge assembly is in the second position.

The mouthpiece and the liquid storage portion may have a rectangular shape, preferably wherein the width is greater than the depth. The width may be at least 1.5 times greater than the depth, preferably at least 2 times greater, more preferably at least 3 times greater. In the rectangular embodiment of the cartridge assembly, the cartridge assembly may comprise two larger sagittal surfaces and two smaller lateral surfaces. In the rectangular embodiment of the cartridge assembly, the first and second locking elements may be positioned on the two smaller lateral surfaces. In the rectangular embodiment of the cartridge assembly, the first and second locking elements may be positioned at the smaller lateral surfaces.

Alternatively, the mouthpiece and the liquid storage portion may have a cylindrical shape. In the cylindrical embodiment of the cartridge assembly, the first and second locking elements may extend radially with respect to the longitudinal axis of the cartridge.

The cartridge assembly may not comprise electrical contacts. Thereby manufacturing costs may be reduced. A cartridge assembly without electrical contacts may have a simpler design.

The cartridge assembly may be based on bio-polymers. The cartridge assembly may be based on bio-polymers, carbon and silica-based materials. Thereby the cartridge assembly may be sustainable.

The present invention further relates to a method for establishing a fluid flow in the cartridge assembly as described herein. The method may comprise moving the mouthpiece from the first into the second position by simultaneously pushing the mouthpiece in an axial direction and pressing the mouthpiece at a sagittal surface transversally to the longitudinal axis of the cartridge or rotating the mouthpiece.

The present invention further relates to a method for establishing a fluid flow in the cartridge assembly as described herein. The method comprises moving the mouthpiece from the first into the second position by simultaneously pushing the mouthpiece in an axial direction and pressing the mouthpiece at a sagittal surface transversally to the longitudinal axis of the cartridge or rotating the mouthpiece. The user may push the mouthpiece at the proximal end.

By pressing the mouthpiece or rotating of the mouthpiece, the first and second locking elements may be disengaged. By axially pushing the mouthpiece, the first locking element may be moved from the distal recess to the proximal recess.

The method may further comprise moving the mouthpiece from the second into the first position by simultaneously drawing the mouthpiece in an axial direction and pressing the mouthpiece at a sagittal surface transversally to the longitudinal axis of the cartridge or rotating the mouthpiece.

In the rectangular embodiment of the cartridge assembly, the user may press the mouthpiece on the two larger sagittal surfaces transversally to the longitudinal axis of the cartridge assembly. Thereby the two smaller lateral surfaces may be deformed. If the first and second locking elements are positioned on the two smaller side surfaces of the cartridge assembly, the first locking element may disengage from the second locking element. The user may press the larger surfaces and simultaneously push the mouthpiece to move the mouthpiece from the first into the second position. The user may press the larger surfaces and simultaneously draw the mouthpiece to move the mouthpiece from the second into the first position.

In the cylindrical embodiment of the cartridge assembly, the user may rotate and push the mouthpiece to move the mouthpiece from the first into the second position. In the cylindrical embodiment of the cartridge assembly, the user may rotate and draw the mouthpiece to move the mouthpiece from the second into the first position. Alternatively or additionally, the user may press the mouthpiece on the peripheral wall to deform the wall. Thereby the first and second locking element may be disengaged.

Providing a moving mechanism of the cartridge assembly that comprises pushing and pressing or pushing and rotating can be child secure. A child may be not able to coordinate such a movement.

The present invention further relates to an aerosol-generating system, comprising the cartridge assembly as described herein and an aerosol-generating device. The aerosol-generating device may comprise a heating chamber for insertion of the cartridge assembly and at least one inductor coil for inductively heating the cartridge assembly.

The present invention further relates to an aerosol-generating system, comprising the cartridge assembly as described herein and an aerosol-generating device. The aerosol-generating device comprises a heating chamber for insertion of the cartridge assembly and at least one inductor coil for inductively heating the cartridge assembly.

The inductor coil may at least partly circumscribe the heating chamber. The inductor coil may be a planar inductor coil or a helical inductor coil. If the cartridge assembly is the rectangular embodiment, the inductor coil may be a planar inductor. If the cartridge assembly is the cylindrical embodiment, the inductor coil may be a helical inductor coil.

The susceptor heating element may be arranged to be aligned with the inductor coil, when the cartridge assembly is in the second position.

The susceptor heating element may not be aligned with the inductor coil, when the cartridge assembly is in the first position. Thereby the aerosol-generating system may only work when the user desires it. The aerosol-generating system may be child secure.

The inductor coil may generate an alternating magnetic field. The susceptor heating element of the mouthpiece may be inside the alternating magnetic field, when the cartridge assembly is in the second position. The susceptor heating element of the mouthpiece may be outside the alternating magnetic field, when the cartridge assembly is in the first position.

The liquid storage portion of the aerosol-generating article may comprise one or both of a liquid aerosol-forming substrate and a liquid sensorial media. The liquid sensorial media may comprise a flavorant. The liquid sensorial media may comprise nicotine. The liquid aerosol-forming substrate or liquid sensorial media may comprise a flavoring, for example menthol or herbal compounds. The liquid aerosol-forming substrate or the liquid sensorial media may comprise nicotine. The liquid aerosol-forming substrate or the liquid sensorial media may comprise a botanical content, for example CBD.

The tubular wick may comprise cotton. The tubular wick may be made of cotton.

The tubular wick may be a porous element. The tubular wick may be capable of absorbing liquid from the airflow. The tubular wick may comprise a capillary material. The capillary material may have a fibrous or spongy structure. The capillary material preferably comprises a bundle of capillaries. For example, the capillary material may comprise a plurality of fibres or threads or other fine bore tubes. The fibres or threads may be generally aligned to convey liquid from the distal part of the wick element to the proximal part of the wick element. Alternatively, the capillary material may comprise sponge-like or foam-like material. The structure of the capillary material may form a plurality of small bores or tubes, through which the liquid can be transported by capillary action. The capillary material may comprise any suitable material or combination of materials. Examples of suitable materials are a sponge or foam material, ceramic- or graphite-based materials in the form of fibres or sintered powders, foamed metal or plastics materials, a fibrous material, for example made of spun or extruded fibres, such as cellulose acetate, polyester, or bonded polyolefin, polyethylene, ethylene or polypropylene fibres, nylon fibres or ceramic. The capillary material may have any suitable capillarity and porosity so as to be used with different liquid physical properties. The liquid has physical properties, including but not limited to viscosity, surface tension, density, thermal conductivity, boiling point and vapour pressure, which allow the liquid to be transported through the capillary material by capillary action. The capillary material may be configured to convey the aerosol-forming substrate to the proximal part of the wick element and to the susceptor element. The capillary material may extend into interstices in the susceptor element.

As used herein the term ‘liquid sensorial media’ relates to a liquid composition capable of modifying an airflow in contact with the liquid sensorial media. The modification of the airflow may be one or more of forming an aerosol or a vapor, cooling an airflow, and filtering an airflow. For example, the liquid sensorial media may comprise an aerosol-forming substrate capable of releasing volatile compounds that can form an aerosol or a vapor. Preferably, the aerosol-forming substrate in the liquid sensorial media is a flavorant or comprises a flavorant. Alternatively or in addition, the liquid sensorial media may comprise one or both of a cooling substance for cooling an airflow passing through the liquid sensorial media and a filter substance for capturing unwanted components in the airflow. Water may be used as a cooling substance. Water may be used as a filtering substance for capturing particles such as dust particles from the airflow. The liquid sensorial media may serve as one or more of a nicotine providing liquid, a flavor enhancer, and a volume enhancer.

As used herein, the term ‘aerosol-forming substrate’ relates to a substrate capable of releasing volatile compounds that can form an aerosol or a vapor. Such volatile compounds may be released by heating the aerosol-forming substrate. The aerosol-forming substrate may be in solid form or may be in liquid form. The terms ‘aerosol’ and ‘vapor’ are used synonymously.

The aerosol-forming substrate may be part of an aerosol-generating article. The aerosol-forming substrate may be part of the liquid held in the liquid storage portion of the aerosol-generating article. The aerosol-forming substrate may be part of the liquid sensorial media held in the liquid storage portion of the aerosol-generating article. The liquid storage portion may contain a liquid aerosol-forming substrate. Alternatively or in addition, the liquid storage portion may contain a solid aerosol-forming substrate. For example, the liquid storage portion may contain a suspension of a solid aerosol-forming substrate and a liquid. Preferably, the liquid storage portion contains a liquid aerosol-forming substrate.

Preferably, a liquid nicotine or flavor/flavorant containing aerosol-forming substrate may be employed in the liquid storage portion of the aerosol-generating article.

The aerosol-forming substrate may comprise nicotine. The nicotine-containing aerosol-forming substrate may be a nicotine salt matrix.

The aerosol-forming substrate may comprise plant-based material. The aerosol-forming substrate may comprise tobacco. The aerosol-forming substrate may comprise a tobacco-containing material including volatile tobacco flavour compounds which are released from the aerosol-forming substrate upon heating. Alternatively, the aerosol-forming substrate may comprise a non-tobacco material. The aerosol-forming substrate may comprise homogenised plant-based material. The aerosol-forming substrate may comprise homogenised tobacco material. Homogenised tobacco material may be formed by agglomerating particulate tobacco.

The aerosol-forming substrate may comprise at least one aerosol-former. An aerosol-former is any suitable known compound or mixture of compounds that, in use, facilitates formation of a dense and stable aerosol and that is substantially resistant to thermal degradation at the temperature of operation of the device. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as triethylene glycol, 1, 3-butanediol. Preferably, the aerosol former is glycerine. Where present, the homogenised tobacco material may have an aerosol-former content of equal to or greater than 5 percent by weight on a dry weight basis, and preferably from 5 percent to 30 percent by weight on a dry weight basis. The aerosol-forming substrate may comprise other additives and ingredients, such as flavourants.

As used herein, the term ‘aerosol-generating article’ refers to an article comprising an aerosol-forming substrate that is capable of releasing volatile compounds that can form an aerosol. For example, an aerosol-generating article may be an article that generates an aerosol that is directly inhalable by the user drawing or puffing on a mouthpiece at a proximal or user-end of the device. An aerosol-generating article may be disposable. The aerosol-generating article may be insertable into the heating chamber of the aerosol-generating device.

As used herein, the term ‘liquid storage portion’ refers to a storage portion comprising a liquid sensorial media and, additionally or alternatively, an aerosol-forming substrate that is capable of releasing volatile compounds that can form an aerosol. The liquid storage portion may be configured as a container or a reservoir for storing the liquid aerosol-forming substrate.

The liquid storage portion may be configured as a replaceable tank or container. The liquid storage portion may be any suitable shape and size. For example, the liquid storage portion may be substantially cylindrical. The cross-section of the liquid storage portion may, for example, be substantially circular, elliptical, square or rectangular.

As used herein, the term ‘aerosol-generating device’ refers to a device that interacts with one or both of an aerosol-generating article and a cartridge to generate an aerosol.

As used herein, the term ‘aerosol-generating system’ refers to the combination of an aerosol-generating device with one or both of a cartridge and an aerosol-generating article. In the system, the aerosol-generating device and one or both of the aerosol-generating article and the cartridge cooperate to generate a respirable aerosol.

Preferably, the aerosol-generating device is portable. The aerosol-generating device may have a size comparable to a conventional cigar or cigarette. The device may be an electrically operated smoking device. The device may be a handheld aerosol-generating device. The aerosol-generating device may have a total length between 30 millimetres and 150 millimetres. The aerosol-generating device may have an external diameter between 5 millimetres and 30 millimetres.

The aerosol-generating device may comprise a housing. The housing may be elongate. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. Preferably, the material is light and non-brittle.

The housing may comprise at least one air inlet. The housing may comprise more than one air inlet.

The aerosol-generating device may comprise a heating element. The heating element may comprise at least one inductor coil for inductively heating one or more susceptors.

Operation of the heating element may be triggered by a puff detection system. Alternatively, the heating element may be triggered by pressing an on-off button, held for the duration of the user's puff. The puff detection system may be provided as a sensor, which may be configured as an airflow sensor to measure the airflow rate. The airflow rate is a parameter characterizing the amount of air that is drawn through the airflow path of the aerosol-generating device per time by the user. The initiation of the puff may be detected by the airflow sensor when the airflow exceeds a predetermined threshold. Initiation may also be detected upon a user activating a button. The sensor may also be configured as a pressure sensor.

The aerosol-generating device may include a user interface to activate the aerosol-generating device, for example a button to initiate heating of the aerosol-generating device or a display to indicate a state of the aerosol-generating device or of the aerosol-forming substrate.

The aerosol-generating device may include additional components, such as, for example a charging unit for recharging an on-board electric power supply in an electrically operated or electric aerosol-generating device.

As used herein, the term ‘proximal’ refers to a user-end, or mouth-end of the aerosol-generating device or system or a part or portion thereof, and the term ‘distal’ refers to the end opposite to the proximal end. When referring to the heating chamber, the term ‘proximal’ refers to the region closest to the open end of the cavity and the term ‘distal’ refers to the region closest to the closed end.

As used herein, the terms ‘upstream’ and ‘downstream’ are used to describe the relative positions of components, or portions of components, of the aerosol-generating device in relation to the direction in which a user draws on the aerosol-generating device during use thereof.

The term ‘airflow path’ as used herein denotes a channel suitable to transport gaseous media. An airflow path may be used to transport ambient air. An airflow path may be used to transport an aerosol. An airflow path may be used to transport a mixture of air and aerosol.

As used herein, a ‘susceptor’ or ‘susceptor element’ means an element that heats up when subjected to an alternating magnetic field. This may be the result of eddy currents induced in the susceptor element, hysteresis losses, or both eddy currents and hysteresis losses. During use, the susceptor element is located in thermal contact or close thermal proximity with an aerosol-forming substrate received in the aerosol-generating device or the aerosol-generating article. In this manner, the aerosol-forming substrate is heated by the susceptor such that an aerosol is formed.

The susceptor material may be any material that can be inductively heated to a temperature sufficient to aerosolize an aerosol-forming substrate. The following examples and features concerning the susceptor may apply to one or both of the susceptor element of the cartridge, a susceptor of an aerosol-generating device, and a susceptor of an aerosol-generating article. Suitable materials for the susceptor material include graphite, molybdenum, silicon carbide, stainless steels, niobium, aluminium, nickel, nickel containing compounds, titanium, and composites of metallic materials. Preferred susceptor materials comprise a metal or carbon. Advantageously the susceptor material may comprise or consists of a ferromagnetic or ferri-magnetic material, for example, ferritic iron, a ferromagnetic alloy, such as ferromagnetic steel or stainless steel, ferromagnetic particles, and ferrite. A suitable susceptor material may be, or comprise, aluminium. The susceptor material may comprise more than 5 percent, preferably more than 20 percent, more preferably more than 50 percent, or more than 90 percent of ferromagnetic, ferri-magnetic or paramagnetic materials. Preferred susceptor materials may be heated to a temperature in excess of 250 degrees Celsius without degradation.

The susceptor material may be formed from a single material layer. The single material layer may be a steel layer.

The susceptor material may comprise a non-metallic core with a metal layer disposed on the non-metallic core. For example, the susceptor material may comprise metallic tracks formed on an outer surface of a ceramic core or substrate.

The susceptor material may be formed from a layer of austenitic steel. One or more layers of stainless steel may be arranged on the layer of austenitic steel. For example, the susceptor material may be formed from a layer of austenitic steel having a layer of stainless steel on each of its upper and lower surfaces. The susceptor element may comprise a single susceptor material. The susceptor element may comprise a first susceptor material and a second susceptor material. The first susceptor material may be disposed in intimate physical contact with the second susceptor material. The first and second susceptor materials may be in intimate contact to form a unitary susceptor. In certain embodiments, the first susceptor material is stainless steel and the second susceptor material is nickel. The susceptor element may have a two-layer construction. The susceptor element may be formed from a stainless steel layer and a nickel layer.

Intimate contact between the first susceptor material and the second susceptor material may be made by any suitable means. For example, the second susceptor material may be plated, deposited, coated, clad or welded onto the first susceptor material. Preferred methods include electroplating, galvanic plating and cladding.

The aerosol-generating device may a power supply for powering the heating element. The power supply may comprise a battery. The power supply may be a lithium-ion battery. Alternatively, the power supply may be a nickel-metal hydride battery, a nickel cadmium battery, or a lithium-based battery, for example a lithium-cobalt, a lithium-iron-phosphate, lithium titanate or a lithium-polymer battery. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

The power supply may be a direct current (DC) power supply. In one embodiment, the power supply is a DC power supply having a DC supply voltage in the range of 2.5 Volts to 4.5 Volts and a DC supply current in the range of 1 Amp to 10 Amps (corresponding to a DC power supply in the range of 2.5 Watts to 45 Watts). The aerosol-generating device may advantageously comprise a direct current to alternating current (DC/AC) inverter for converting a DC current supplied by the DC power supply to an alternating current. The DC/AC converter may comprise a Class-D, Class-C or Class-E power amplifier. The AC power output of the DC/AC converter is supplied to the induction coil.

The power supply may be adapted to power an inductor coil and may be configured to operate at high frequency. A Class-E power amplifier is preferable for operating at high frequency. As used herein, the term ‘high frequency oscillating current’ means an oscillating current having a frequency of between 500 kilohertz and 30 megahertz. The high frequency oscillating current may have a frequency of from 1 megahertz to 30 megahertz, preferably from 1 megahertz to 10 megahertz, and more preferably from 5 megahertz to 8 megahertz.

In another embodiment the switching frequency of the power amplifier may be in the lower kHz range, e.g. between 100 kHz and 400 KHz. In the embodiments, where a Class-D or Class-C power amplifier is used, switching frequencies in the lower kHz range are particularly advantageous.

The aerosol-generating device may comprise a controller. The controller may be electrically connected to the inductor coil. The controller may be electrically connected to the first induction coil and to the second induction coil. The controller may be configured to control the electrical current supplied to the induction coil(s), and thus the magnetic field strength generated by the induction coil(s).

The power supply and the controller may be connected to the inductor coil(s).

The controller may be configured to be able to chop the current supply on the input side of the DC/AC converter. This way the power supplied to the inductor coil(s) may be controlled by conventional methods of duty-cycle management.

Below, there is provided a non-exhaustive list of non-limiting examples. Any one or more of the features of these examples may be combined with any one or more features of another example, embodiment, or aspect described herein.

Example A: A cartridge assembly for an aerosol-generating device, the cartridge comprising
a mouthpiece comprising a sealing portion; and
a liquid storage portion comprising a fluid permeable portion, wherein the mouthpiece and the liquid storage portion are axially movable relative to each other between a first position and a second position, wherein, in the first position, the fluid permeable portion of the liquid storage portion is sealed by the sealing portion of the mouthpiece.

Example B: The cartridge assembly according to Example A, wherein the mouthpiece and the liquid storage portion are axially movable towards or apart from each other between the first position and the second position.

Example C: The cartridge assembly according to any of the preceding examples, wherein the first position is an extended position and the second position is a retracted position.

Example D: The cartridge assembly according to any of the preceding examples, wherein, in the first position, a proximal end of the mouthpiece and a distal end of the liquid storage portion are axially more distanced than in the second position.

Example E: The cartridge assembly according to any of the preceding examples, wherein the mouthpiece and the liquid storage portion are lockingly engaged in the first position.

Example F: The cartridge assembly according to any of the preceding examples, wherein the mouthpiece and the liquid storage portion are lockingly engaged in the second position.

Example G: The cartridge assembly according to any of the preceding examples, wherein the mouthpiece is configured to receive a top portion of the liquid storage portion.

Example H: The cartridge assembly according to any of the preceding examples, wherein the mouthpiece further comprises a tubular air management element confining an airflow channel, and wherein the tubular air management element comprises the sealing portion.

Example I: The cartridge assembly according to Example H, wherein the tubular air management element comprises a tubular porous portion.

Example J: The cartridge assembly according to Example I, wherein the tubular air management element comprises a heating element arranged adjacent the tubular porous portion, wherein the heating element is coaxially circumscribed by the tubular porous portion, and wherein the heating element is in direct contact with the tubular porous portion.

Example K: The cartridge assembly according to Example J, wherein the heating element is a susceptor heating element, preferably a porous susceptor heating element.

Example L: The cartridge assembly according to any of the preceding examples, wherein the liquid storage portion comprises a liquid reservoir and a hollow tubular core element, wherein the hollow tubular core element is circumscribed by the liquid reservoir, wherein the hollow tubular core element comprises the fluid permeable portion arranged at a distal end of the liquid reservoir, wherein the hollow tubular core element is configured to receive the tubular air management element of the mouthpiece of Example H, and wherein the tubular air management element is axially movable within the hollow tubular core element of the liquid storage portion.

Example M: The cartridge assembly according to any of the preceding examples, wherein the fluid permeable portion of the liquid storage portion is a tubular wick element.

Example N: The cartridge assembly according to claim Example M, wherein the tubular wick element is a porous ceramic wick element, preferably wherein the porosity of the ceramic wick element is between 30 percent to 80 percent, preferably 40 percent to 70 percent, most preferably 50 percent to 60 percent.

Example O: The cartridge assembly according to Example J, wherein, in the second position, the fluid permeable portion and the heating element are transversally aligned so that the tubular porous portion is in direct contact with the fluid permeable portion to provide a fluid connection from the liquid reservoir of Example L towards to the heating element.

Example P: The cartridge assembly according to any of the preceding examples, wherein the liquid storage portion comprises a first locking element at an outer surface and the mouthpiece comprises a second locking element at an inner surface or wherein the liquid storage portion comprises the second locking element at an outer surface and the mouthpiece comprises the first locking element at an inner surface, wherein the first locking element and the second locking element are configured to lockingly engage with each other.

Example Q: The cartridge assembly according to Example P, wherein the first locking element and the second locking element comprise male and female connection elements.

Example R: The cartridge assembly according to Example P, wherein the first locking element and the second locking element comprise form-fit connection elements.

Example S: The cartridge assembly according to Example P, wherein the first locking element and the second locking element comprise snap-fit connection elements.

Example T: The cartridge assembly according to Example P, wherein the first locking element and the second locking element comprise bayonet connection elements.

Example U: The cartridge assembly according to any of Examples P to T, wherein the first and second locking elements are configured to disengage when the mouthpiece and the liquid storage portion are axially moved from the first position to the second position, or vice versa.

Example V: The cartridge assembly according to any of Examples P to U, wherein the first locking element comprises an elastic protrusion, wherein the second locking element comprises a distal recess, and wherein the elastic protrusion is configured to lockingly engage with the distal recess in the first position.

Example W: The cartridge assembly according to Example V, wherein the second locking element comprises a proximal recess, wherein the proximal recess is closer to the proximal end of the mouthpiece than the distal recess, and wherein the elastic protrusion is configured to lockingly engage with the proximal recess in the second position.

Example X: The cartridge assembly according to Examples V or W, wherein the elastic protrusion comprises two oppositely arranged transversally extending elastic protrusions, wherein the distal recess comprises two oppositely arranged recesses, and wherein the transversally extending elastic protrusions are configured to lockingly engage with the two oppositely arranged recesses in the first position.

Example Y: The cartridge assembly according to Examples W or X, wherein the proximal recess comprises two oppositely arranged recesses, and wherein the transversally extending elastic protrusions are configured to lockingly engage with the two oppositely arranged recesses in the second position.

Example Z: The cartridge assembly according to any of Examples P to Y, wherein the first and second locking elements extend radially with respect to the longitudinal axis of the cartridge.

Example AA: The cartridge assembly according to any of the preceding examples, wherein the sealing portion comprises a tubular sealing element, wherein the tubular sealing element circumscribes a distal portion of the tubular air management element of Example I, wherein the tubular sealing element is arranged distal to the porous portion, and wherein the tubular sealing element has at least the same axial length as the tubular wick element of Example M.

Example AB: The cartridge assembly according to Example AA, wherein the sealing portion further comprises a first ring-shaped sealing element and a second ring-shaped sealing element, and wherein the tubular sealing element is arranged between the first and second ring-shaped sealing elements.

Example AC: The cartridge assembly according to Example AB, wherein the mouthpiece further comprises a third ring-shaped sealing element, and wherein the tubular porous portion is arranged between the second and the third ring-shaped sealing elements.

Example AD: The cartridge assembly according to Examples AB or AC, wherein the ring-shaped sealing elements are configured as o-rings.

Example AE: The cartridge assembly according to Examples AC or AD, wherein the first and second ring-shaped sealing elements are configured to hermetically seal the tubular wick element, when the cartridge assembly is in the first position, and wherein the second and third ring-shaped sealing elements are configured to hermetically seal the tubular wick element, when the cartridge assembly is in the second position.

Example AF: The cartridge assembly according to any of the preceding examples, wherein the mouthpiece and the liquid storage portion have a rectangular shape, preferably wherein the width is greater than the depth.

Example AG: The cartridge assembly according to Example AF, wherein the width is at least 1.5 times greater than the depth, preferably at least 2 times greater, more preferably at least 3 times greater.

Example AH: The cartridge assembly according to any of Examples A to AE, wherein the mouthpiece and the liquid storage portion have a cylindrical shape.

Example AI: The cartridge assembly according to any of the preceding examples, wherein the cartridge assembly does not comprise electrical contacts.

Example AJ: A method for establishing a fluid flow in the cartridge assembly of any of the preceding examples, wherein the method comprises moving the mouthpiece from the first into the second position by simultaneously
pushing the mouthpiece in an axial direction; and
pressing the mouthpiece at a sagittal surface transversally to the longitudinal axis of the cartridge or rotating the mouthpiece.

Example AK: The method of Example AJ, wherein, by pressing the mouthpiece or rotating of the mouthpiece, the first and second locking elements of Example P are disengaged.

Example AL: The method of Examples AJ or AK, wherein, by axially pushing the mouthpiece, the first locking element of Example V is moved from the distal recess to the proximal recess of Example W.

Example AM: An aerosol-generating system, comprising the cartridge assembly according to any of Examples A to AI; and an aerosol-generating device, comprising a heating chamber for insertion of the cartridge assembly and at least one inductor coil for inductively heating the cartridge assembly.

Example AN: The aerosol-generating system of claim Example AM, wherein the inductor coil at least partly circumscribes the heating chamber.

Example AO: The aerosol-generating system of Example AM, wherein the inductor coil is a planar inductor coil or a helical inductor coil.

Example AP: The aerosol-generating system of any of Examples AM to AO, wherein the susceptor heating element is arranged to be aligned with the inductor coil, when the cartridge assembly is in the second position.

Example AQ: The aerosol-generating system of any of Examples AM to AP, wherein the susceptor heating element is not aligned with the inductor coil, when the cartridge assembly is in the first position.

Features described in relation to one embodiment may equally be applied to other embodiments of the invention.

The invention will be further described, by way of example only, with reference to the accompanying drawings in which:

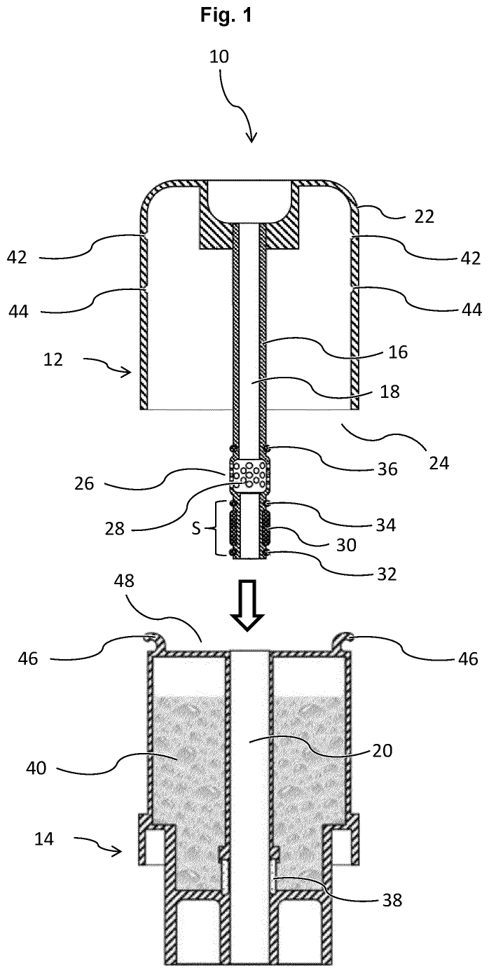

FIG. 1 shows a cross sectional view of a cartridge assembly in a disassembled state;

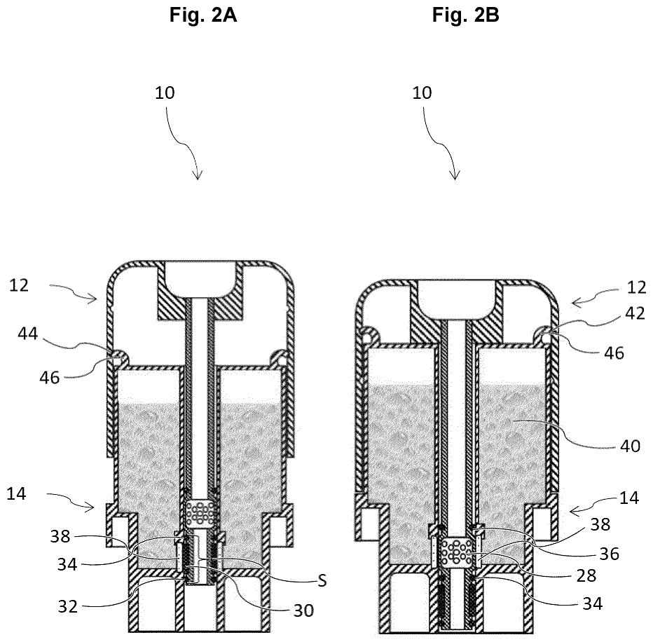

FIGS. 2A and 2B show a cross sectional view of the cartridge assembly in an assembled state;

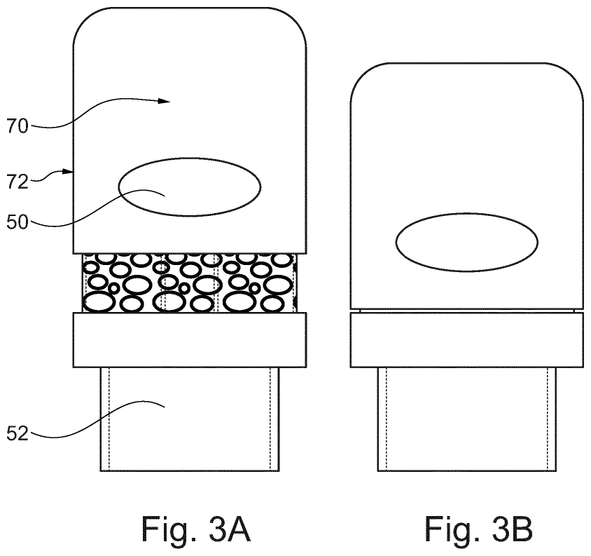

FIGS. 3A and 3B show an outer view of the rectangular embodiment of the cartridge assembly;

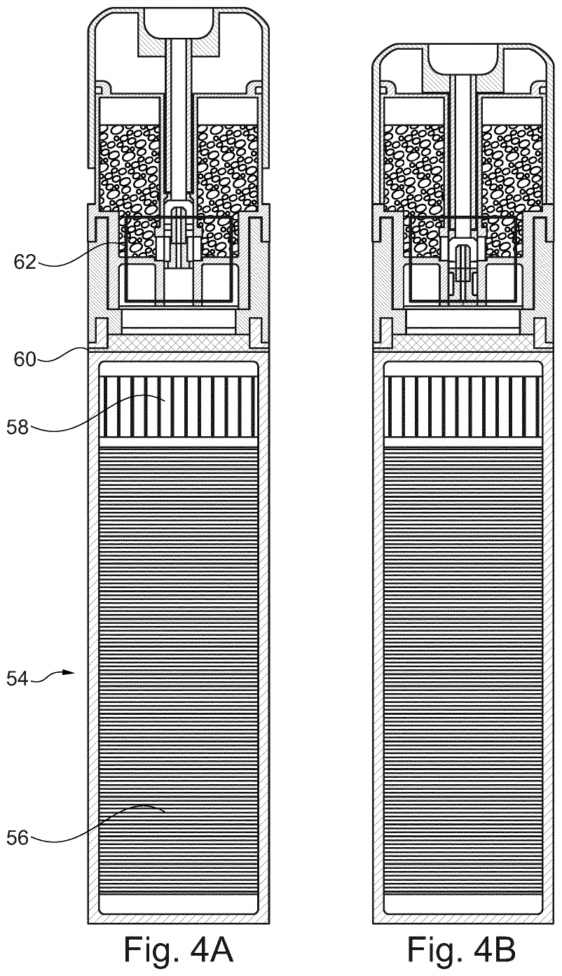

FIGS. 4A and 4B show a cross sectional view of the rectangular embodiment of the cartridge assembly with an aerosol-generating device;

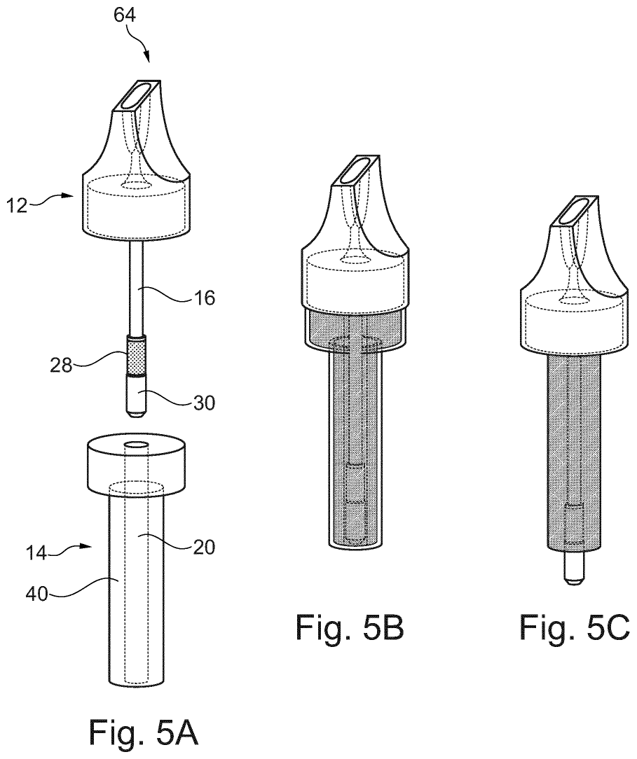

FIGS. 5A, 5B and 5C show an outer view of the cylindrical embodiment of the cartridge assembly; and

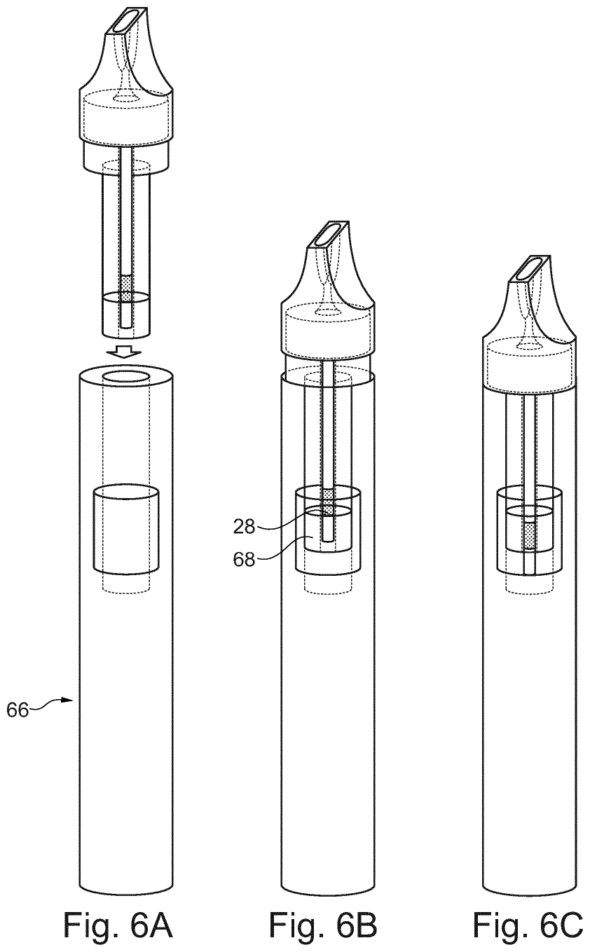

FIGS. 6A, 6B and 6C show an outer view of the cylindrical embodiment of the cartridge assembly with an aerosol-generating device.

FIG. 1 shows a cross sectional view of a cartridge assembly 10. The cartridge assembly 10 comprises a mouthpiece 12 and a liquid storage portion 14. The mouthpiece 12 comprises a tubular air management element 16 confining an airflow channel 18. The liquid storage portion 16 comprises a hollow tubular core element 20. The tubular air management element 16 can be inserted into the hollow tubular core element 20. The mouthpiece comprises a peripheral wall 22. The peripheral wall 22 confines a cavity 24. When the tubular air-management element 16 is inserted into the hollow tubular core element 20, the peripheral wall 22 overlaps the liquid storage portion 14.

The tubular air management element 16 comprises a tubular porous portion 26. The tubular air management element 16 comprises a porous susceptor 28. The tubular air management element 16 is circumscribed by a tubular sealing element 30. The tubular sealing element 30 is sandwiched by a first ring-shaped sealing element 32 and a second ring-shaped sealing element 34. The tubular sealing element 30, the first ring-shaped sealing element 23 and the second sealing element 34 provide a sealing portion S. The tubular air management element 16 further comprises a third ring-shaped sealing element 36.

The hollow tubular core element 20 comprises a tubular wick element 38. The hollow tubular core element 20 is surrounded by a liquid reservoir 40. The tubular wick element 38 provides a fluid connection from the liquid reservoir 40 to the hollow tubular core element 20. The tubular wick element 38 is arranged at a distal end of the liquid reservoir 40.

The mouthpiece 12 comprises two proximal recesses 42 and two distal recesses 44 on an inner side of the peripheral wall 22. The liquid storage portion 14 comprises two elastic protrusions 46 on an outer side of the proximal transversal wall 48.

FIG. 2A shows a cross sectional view the cartridge assembly 10 in a first position. In the first position the elastic protrusions 46 of the liquid storage portion 14 are lockingly engaged with the distal recesses 44 of the mouthpiece 12. In the first position the tubular wick element 38 is sealed by the sealing portion S. In the first position the tubular sealing element 30 and the tubular wick element 38 are in contact with each other. The first and second ring-shaped sealing elements 32 and 34 provide an additional sealing of the tubular wick element 38. When the mouthpiece 12 and the liquid storage portion 14 are axially moved towards each other the cartridge assembly 10 is moved from the first into the second position.

FIG. 2B shows a cross sectional view the cartridge assembly 10 in the second position. In the second position the elastic protrusions 46 of the liquid storage portion 14 are lockingly engaged within the proximal recesses 42 of the mouthpiece 12. The porous susceptor 28 is aligned with the tubular wick element 38 to provide a fluid connection from the liquid reservoir 40 to the porous susceptor 28. The second and third ring-shaped sealing elements 34 and 36 provide sealing of the porous susceptor 28 and the tubular wick element 38.

FIGS. 3A and 3B show an outer view of the rectangular embodiment of the cartridge assembly 10. FIG. 3A shows the rectangular cartridge assembly in the first position and FIG. 3B shows the rectangular cartridge assembly in the second position. The peripheral wall 22 of the mouthpiece 12 can comprise two recesses 50 on the two sagittal surfaces 70. The other recess 50 is on a back side (not shown). By pressing the recesses 50, the peripheral wall 22 deforms. Thereby the elastic protrusions 46 on the lateral surface 72 are disengaged from the distal recesses 44, when the cartridge assembly 10 is in the first position, or from the proximal recesses 42, when the cartridge assembly 10 is in the second position. The cartridge assembly 10 comprises a connection portion 52. The connection portion can be connected to an aerosol-generating device 54.

FIGS. 4A and 4B show a cross-sectional view of the rectangular embodiment of the cartridge assembly 10 within an aerosol-generating device 54. The aerosol-generating device comprises a power supply 56, a controller 58 and an air inlet 60. The square 62 indicates where the alternating magnetic field is generated by a planar inductor coil (not shown).

FIG. 4A shows the cartridge assembly 10 in the first position and FIG. 4B shows the cartridge assembly in the second position. In the first position the porous susceptor 28 is outside the alternating magnetic field 62. Therefore, the porous susceptor 28 cannot be heated by the inductor coil. In the second position the porous susceptor 28 is within the alternating magnetic field 62. Thereby the porous susceptor 28 is heated by the inductor coil and the liquid aerosol-forming substrate can be aerosolized.

FIGS. 5A, 5B and 5C show an outer view of a cylindrical embodiment of a cartridge assembly 64. In this embodiment the proximal recesses 42 may be connected to form one annular proximal recess (not shown). The distal recesses 44 may also be connected to form one annular distal recess (not shown). The elastic protrusion 46 may also be one single annular elastic protrusion (not shown). The other components of the cartridge assembly 64 correspond to the components of the cartridge assembly 10.

FIGS. 6A, 6B and 6C show an outer view of the cylindrical cartridge assembly 64 with a cylindrical aerosol-generating device 66. The aerosol-generating device 66 comprises an inductor coil 68. When the cylindrical cartridge assembly 64 is in the first position, as shown in FIG. 6B, the porous susceptor 28 cannot pair with the inductor coil 68. When the cylindrical cartridge assembly is in the second position, as shown in FIG. 6C, the porous susceptor 28 can pair with the inductor coil 68. Thereby heat can be generated and the aerosol-forming substrate can be aerosolized.

1.-15. (canceled)

16. A cartridge assembly for an aerosol-generating device, the cartridge assembly comprising:
a mouthpiece comprising a sealing portion; and
a liquid storage portion comprising a fluid-permeable portion,
wherein the mouthpiece and the liquid storage portion are axially movable relative to each other between a first position and a second position,
wherein, in the first position, the fluid-permeable portion of the liquid storage portion is sealed by the sealing portion of the mouthpiece, and
wherein the fluid-permeable portion of the liquid storage portion is a tubular wick element.

17. The cartridge assembly according to claim 16, wherein one or both of the mouthpiece and the liquid storage portion are lockingly engaged in the first position and the mouthpiece and the liquid storage portion are lockingly engaged in the second position.

18. The cartridge assembly according to claim 16,
wherein the mouthpiece further comprises a tubular air management element confining an airflow channel, and
wherein the tubular air management element comprises the sealing portion.

19. The cartridge assembly according to claim 18, wherein the tubular air management element further comprises a tubular porous portion.

20. The cartridge assembly according to claim 19,
wherein the tubular air management element further comprises a heating element arranged adjacent the tubular porous portion,
wherein the heating element is coaxially circumscribed by the tubular porous portion, and
wherein the heating element is in direct contact with the tubular porous portion.

21. The cartridge assembly according to claim 16,
wherein the liquid storage portion further comprises a liquid reservoir and a hollow tubular core element,
wherein the hollow tubular core element is circumscribed by the liquid reservoir,
wherein the hollow tubular core element comprises the fluid-permeable portion arranged at a distal end of the liquid reservoir,
wherein the mouthpiece further comprises a tubular air management element confining an airflow channel, and the tubular air management element comprises the sealing portion,
wherein the hollow tubular core element is configured to receive the tubular air management element of the mouthpiece, and
wherein the tubular air management element is axially movable within the hollow tubular core element of the liquid storage portion.

22. The cartridge assembly according to claim 16,
wherein the liquid storage portion further comprises a first locking element at an outer surface and the mouthpiece further comprises a second locking element at an inner surface or wherein the liquid storage portion further comprises the second locking element at an outer surface and the mouthpiece further comprises the first locking element at an inner surface, and
wherein the first locking element and the second locking element are configured to lockingly engage with each other.

23. The cartridge assembly according to claim 22, wherein the first locking element and the second locking element are further configured to disengage when the mouthpiece and the liquid storage portion are axially moved from the first position to the second position, or vice versa.

24. The cartridge assembly according to claim 16,
wherein the sealing portion comprises a tubular sealing element,
wherein the mouthpiece further comprises a tubular air management element confining an airflow channel,
wherein the tubular air management element comprises the sealing portion and a tubular porous portion,
wherein the tubular sealing element circumscribes a distal portion of the tubular air management element,
wherein the tubular sealing element is arranged distal to the porous portion, and
wherein the tubular sealing element has at least a same axial length as the tubular wick element.

25. A method for establishing a fluid flow in the cartridge assembly according to claim 16, the method comprising:
moving the mouthpiece from the first position into the second position by simultaneously
pushing the mouthpiece in an axial direction, and
pressing the mouthpiece at a sagittal surface transversally to a longitudinal axis of the cartridge or rotating the mouthpiece.

26. An aerosol-generating system, comprising
the cartridge assembly according to claim 16; and
an aerosol-generating device, comprising a heating chamber configured for insertion of the cartridge assembly and at least one inductor coil for inductively heating the cartridge assembly.

27. The aerosol-generating system according to claim 26, wherein the inductor coil is a planar inductor coil or a helical inductor coil.

28. The aerosol-generating system according to claim 26,
wherein the mouthpiece further comprises a tubular air management element confining an airflow channel,
wherein the tubular air management element comprises the sealing portion,
wherein the tubular air management element further comprises a tubular porous portion,
wherein the tubular air management element further comprises a heating element arranged adjacent the tubular porous portion,
wherein the heating element is coaxially circumscribed by the tubular porous portion,
wherein the heating element is in direct contact with the tubular porous portion,
wherein the heating element is a susceptor heating element, and
wherein the susceptor heating element is arranged to be aligned with the inductor coil, when the cartridge assembly is in the second position.

29. The aerosol-generating system according to claim 28, wherein the susceptor heating element is not aligned with the inductor coil, when the cartridge assembly is in the first position.
